(19) United States
(12) Patent Application Publication
(10) Pub. No.: US 2004/0210926 A1
(43) Pub. Date: Oct. 21, 2004

(54) Controlling access to content

(75) Inventors: Stephen S. Francis, Saratoga, CA (US); Johannes Schmidt, Los Altos Hills, CA (US); David Daney, San Jose, CA (US); Kevin Shen, Sunnyvale, CA (US)

Correspondence Address: FISH & RICHARDSON, PC, 12390 EL CAMINO REAL, SAN DIEGO, CA, 92130-2081, US

(73) Assignee: Avtrex, Inc.

(21) Appl. No.: 10/754,892

(22) Filed: Jan. 8, 2004

Related U.S. Application Data
(60) Provisional application No. 60/439,064, filed on Jan. 8, 2003.

(51) Int. Cl. H04N 7/16

(52) U.S. Cl. 725/25; 725/30

(57) ABSTRACT

Systems and techniques for controlling access to content. In one implementation, a method includes receiving a criterion identifying acceptable television content for a certain accessor, receiving information describing features of currently available television content, comparing the features with the criterion, and allowing the accessor to view the television content only if the features of the television content meet the identifying criterion.

### CROSS-REFERENCE TO RELATED APPLICATION

This application claims the priority of U.S. Provisional Application Serial No. 60/439,064, filed on Jan. 8, 2003 and entitled “CONTROLLING ACCESS TO CONTENT,” the contents of which are incorporated herein by reference.

### BACKGROUND

This disclosure relates to controlling access to content.

The volume of information that is readily accessible using modern communication devices is staggering. For example, audio and/or visual content is accessible using digital and analog radio, digital and analog television, data processing devices such as computers that can receive information over communications networks such as the Internet, and other communication devices.

Once consequence of this torrent of information is the widespread availability of content that, for one reason or another, is considered unacceptable. For example, many parents find “adult” television programming unacceptable for viewing by their children. As another example, some parents find extended viewing of even youth or educational programming by their children unacceptable.

Recording devices such as digital video recorders may dramatically increase the availability of unacceptable content. For example, adult programming that would otherwise be available only at times when parents are in control of the television (e.g., late at night) can be recorded and viewed when parents are not in control of the television (e.g., after school).

### SUMMARY

The present invention provides method and apparatus, including computer-program products, for controlling access to content.

Systems and techniques for controlling access to content. In one aspect, a method includes receiving a criterion identifying acceptable television content for a certain accessor, receiving information describing features of currently available television content, comparing the features with the criterion, and allowing the accessor to view the television content only if the features of the television content meet the identifying criterion.

This and other aspects can include one or more of the following features. The received criterion can be a subject matter criterion identifying a subject matter of content that is acceptable. For example, the criterion can be the name of a particular show that is acceptable for the certain accessor. The information describing features of currently available television content can be received as metadata associated with the currently available television content. Criteria that relate to two or more of a rating of the acceptable television content, a channel of the acceptable television content, and a genre of the acceptable television content can be received.

The criterion can be an indication that television viewing at a current time of day is acceptable and the information can describe features of prerecorded television content. The criterion can identify acceptable television content for a certain individual accessor.

In another aspect, a method includes receiving a description of subject matter of content that is acceptable for access by a content accessor, receiving a description of a time when access to content by the accessor is acceptable, and allowing the accessor to access content having the acceptable subject matter only at the described acceptable time.

This and other aspects can include one or more of the following features. The accessor can be allowed to record content having the acceptable subject matter outside the described acceptable time. The description of the subject matter can be received by receiving a general subject matter criterion that identifies a general subject matter that is acceptable and receiving an additional subject matter criterion that delineates the general subject matter criterion to identify a portion of the general subject matter as acceptable. An account relating to a category of content described by the received description can be established.

The method can also include receiving a description of an amount of access to content by the accessor that is acceptable. The description of the amount can be a daily amount criterion identifying a daily amount of access to content that is acceptable or the description of the amount can be an amount criterion identifying the amount of access to content having the described subject matter. The accessor can be allowed to access the content having the acceptable subject matter only at the described acceptable time up to the acceptable amount. The accessor can be allowed to record content having the acceptable subject matter but beyond the acceptable amount.

A cost criterion identifying a monetary cost of access to content by the accessor that is acceptable can also be received. The description of the timing can be a timing criterion identifying a time when access to content having the described subject matter is acceptable. The method can also include determining whether or not a bonus time allocated for access to content is to be expended and allowing the accessor to access content regardless of the acceptability of the time when access to content by the accessor is acceptable based on a determination that the bonus time is to be expended. The bonus time is independent of the time when access to content by the accessor is acceptable.

In another aspect, a method includes identifying a viewer of television content, logging the viewer's access to the television content in a log, and presenting the log of the viewer's access to a requester of the log.

This and other aspects can include one or more of the following features. The log can be presented by presenting a list identifying a name of the television content and a time of the access to the television content. A criterion identifying acceptable television content can also be presented. The log of the viewer's access can be presented to a controller who can define an access control technique used to control the viewer's access to the television content.

The method can also include controlling the viewer's access to the television content, for example, by allowing the accessor to view the television content only if features of the television content meet a criterion identifying acceptable television content. The criterion can be a subject matter criterion identifying a subject matter of content that is acceptable.

In another aspect, a system includes an access controller to control access of a user to television content. The access controller includes an identification signal receiver configured to receive a signal identifying an individual, an information storage device to store access control information to identify television content that is acceptable for a certain accessor, and access control logic to implement an access control technique allowing the certain accessor access to the television content identified as acceptable by the information stored in the information storage device.

This and other aspects can include one or more of the following features. The access control logic can be machine-readable instructions implemented in a data processing device. The system can also include a television display device to render the television content. The television display device can be integrated into a single housing with the access controller. The identification signal receiver can be an infrared receiver to receive information that identifies the individual. The access controller can also include a display screen to interact with a user who controls the access of the certain accessor to television content. The information storage device can be a disk drive to store machine-readable information.

The described systems and techniques can be implemented to realize one or more of the following advantages. Access to content can be controlled to limit the exposure of certain accessors (such as children) to content. The limits can be established based on different classes of criteria, such as the total amount of content accessed as well as the subject matter of accessed content. These criteria can be relatively detailed in that the definition of acceptable content can be uniquely tailored to the accessor using a number of different criteria. The criteria can be defined on several levels of generality, resulting in increasingly finer tailoring of content to a particular accessor. Moreover, different criteria can be orthogonal in that they are statistically independent of one another and result in precise control of access to content.

A log of content access can be provided to the accessor and to an individual who controls the accessor's access to content. The log can allow an accessor to budget future content access while allowing a controller, such as a parent, to review the content access. This can allow parents to confirm that a particular access control technique is appropriate to a particular child. Moreover, a parent can review a child's content access habits. If this is done with the child, the parent and child can discuss the content access and any issues associated with that access.

Access to content can be controlled by identifying content that is acceptable, rather than content that is unacceptable. This can simplify the input of access control information, since an access control system can enable a small percentage of the available content (e.g., five of 250 television channels) rather than specifically disabling a large percentage of the available content (e.g., denying access to 245 of the 250 channels). Moreover, by identifying acceptable content rather than unacceptable content, the default system behavior is changed. In particular, if new content (e.g., a new channel or television program) is introduced, the new content is, by default, not allowed. As another example, if content is unrated, then the unrated content is, by default, not allowed.

These and other implementations are particularly advantageous when controlling access to television content. In particular, the implementations can be used to control access to both live television and to pre-recorded programs that are viewed at a later time. Moreover, the range of available television programming is broad and the amount of content that is unacceptable for children is large. Many interested parties (e.g., parents) lack the time and determination to constantly screen access to television content. By establishing flexible, intelligent, and/or rule-based techniques to control access to content that can be implemented by computers or other data processing devices, parents can control access to television content in a manner that truly reflects both their intent and the reality of television viewing.

Using the described systems and techniques, access to television content can be controlled by distinguishing between different content using a wide range of features. Examples of such features include the ratings of the content (e.g., either MPAA or TV rating system), the genre of the content (e.g., determined using guide data regarding program (e.g., “movie” or “sports”), the maturity level of the content (e.g., the amount of violence, language, mature themes), the broadcaster of the content (e.g., the television station carrying the content), the time of the day when the content is broadcast (e.g., different for each day of the week or for holidays), the amount of content viewed in a daily or weekly period (e.g., this can be different for each day of the week and different for each channel), the specific nature of content (e.g., a specific television program identified by name or by time and channel), the repetition of the content (e.g., all occurrences of a specific program or each day or week at that time), and the specific name of single occurrence content (e.g., the Superbowl or game seven of the World Series).

The details of one or more implementations are set forth in the accompanying drawings and description below. Other features, objects, and advantages will be apparent from the description and drawings, and from the claims.

### DESCRIPTION OF DRAWINGS

FIG. 1 shows a system where access to content is controlled.

FIG. 2 shows a process for controlling access to content.

FIG. 3 shows a screenshot of a system receiving access control information.

FIG. 4 shows example criteria that can be use to control access to content.

FIG. 5 shows a process for receiving access control information.

FIG. 6 shows a screenshot of a system receiving access control information.

FIG. 7 shows a screenshot of a system receiving access control information.

FIG. 7 shows another process for receiving access control information.

FIG. 9 shows a time bank used to control access to content.

FIGS. 10A and 10B show processes for controlling access to content.

FIGS. 11A and 11B show processes for controlling access to content.

FIGS. 12, 13, 14, 15 show processes for controlling access to content.

FIG. 16 shows an access log used to log access to content.

FIG. 17 shows a time bank used to control access to content.

FIG. 18 shows a process for providing a user with information regarding past access to content.

Like reference symbols in the various drawings indicate like elements.

### DETAILED DESCRIPTION

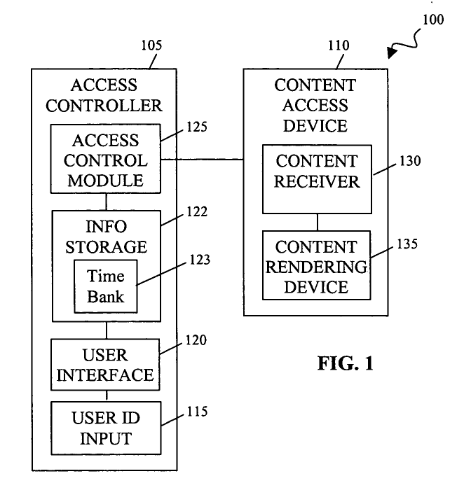

FIG. 1 shows a system 100 where access to content is controlled. Content can include audio, graphic, video, and/or text displays that are rendered for a viewer, a listener, or other accessor. Content can be in analog or digital format. Content can be rendered using any of a number of different appliances or other apparatus that include audio and/or visual display capabilities (e.g., radios, television sets, and computer systems). Content can be considered unacceptable for a number of different reasons. For example, content can include violent subject matter, strong language, or adult subject matter. Content can also lack favorable elements that would make the content worthy of extended viewing, such as artistic merit, positive reviews, or educational subject matter.

System 100 includes an access controller 105 and a content access device 110. Access controller 105 is a device that implements one or more techniques for controlling access to content. For example, access controller 105 can be a digital video recorder (DVR) or a television tuning device such as a cable box, a satellite receiver/tuner, an integrated television tuner, or data processing equipment accessing content over a public network. Content access device 110 is an appliance or other apparatus that an accessor can use to access content. For example, content access device 110 can be a television set, a radio, a computer, a multimedia system, or other device that renders content for a content accessor.

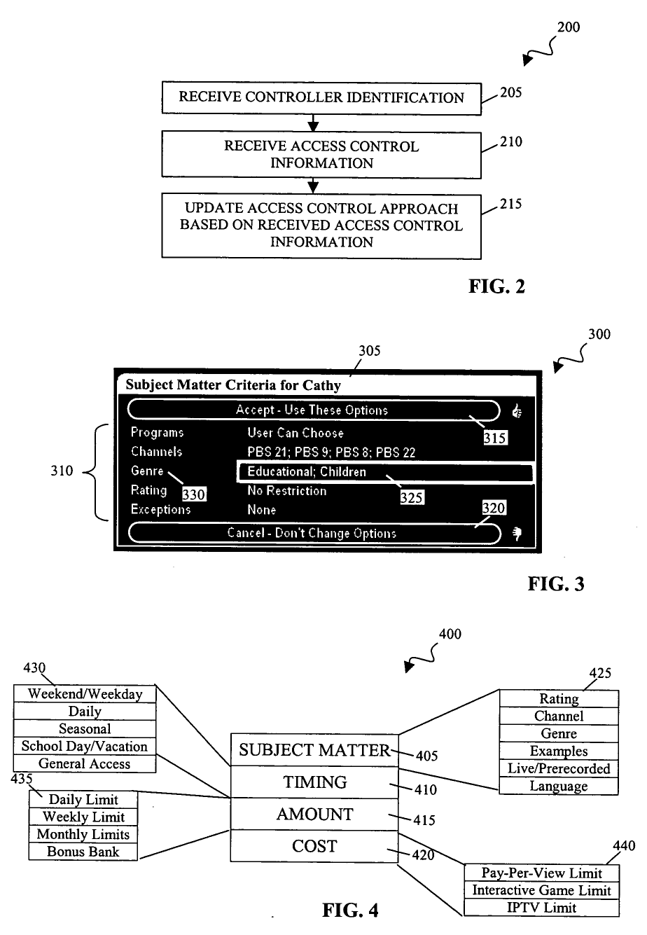

Access controller 105 includes a user identification input device 115, a user interface 120, an access control information storage device 122, and an access control module 125. User identification input device 115 receives a password, a biometric measurement, a key, or a combination thereof to identify a user. For example, user identification input device 115 can include an infrared (IR) receiver, a keyboard, a biometric scanner, or other input device for receiving a user identification. User interface 120 is a device for interacting with a user. User interface 120 can accept commands from a user and return information to the user. Such commands can include updates to access control information (including new or changed subject matter, timing, amount, and cost criteria). The returned information can include the identification of potentially changeable criteria (e.g., as shown in screenshots 300, 600, 700 of FIGS. 3, 6, 7), access logs, and time bank entries. User interface 120 can include one or more of a display screen, a speaker, and a control panel.

Access control information storage device 122 stores information used to perform one or more access control techniques. The stored information can include information for identifying accessors and controllers, as well as criteria established by the controllers for controlling access to content by the accessors. For example, access control information storage device 122 can store lists of groups of criteria for identifying acceptable content and cost accounts for controlling access to content. Access control information storage device 122 can also store entries in a time bank 123. A time bank controls an accounting of the time that a controller has allocated for access to certain content by a certain accessor, as discussed further below. Access control information storage device 122 can be one or more of an active or a passive memory device.

Access control module 125 can include a data processing device and/or software that performs processing activities in accordance with the logic of a set of machine-readable instructions. Access control module 125 can implement one or more techniques for controlling access to content including those described herein. Access control module 125 can retrieve information used in implementing the techniques from information storage device 122. Access control module 125 can also receive information regarding the features of content, e.g., either as metadata associated with the content or through an independent input mechanism.

Content access device 110 includes a content receiver 130 and a content rendering device 135. Content receiver 130 receives content. Content receiver 130 can receive content in an electrical, electromagnetic, or optical signal transmitted from a remote location. Content can be received in isolation or in association with metadata regarding features of the content. Content receiver 130 can be a television or radio antenna/tuner or an I/O port and communication system in a data processing device.

Content rendering device 135 is a device that provides a user with access to the content received by content receiver 130 by rendering the received content. Content rendering device 135 can include audio and/or visual display capabilities. For example, content rendering device 135 can include one or more speakers and display screens, such as a television set or a personal computer.

In operation, access controller 105 receives access control information by interacting with a controller over user identification input device 115 and user interface 120. Access controller 105 can store the access control information in information storage device 122. Using the access control information, access controller 105 establishes an access control technique implemented by access control module 125. The control signals generated by access control module 125 are relayed to content access device 110, where the rendering of content at content rendering device 135 is controlled in accordance with the received control signals.

FIG. 2 shows a process 200 for controlling access to content. Process 200 can be performed by a stand-alone system that communicates with an appliance or other apparatus for rendering content. For example, process 200 can be performed by access controller 105 (FIG. 1). Process 200 can also be performed by a system of elements built into an apparatus for rendering content.

Information that identifies a user as a controller of access to content can be received at 205. The information can be received over a variety of input devices (such as user identification input 115 (FIG. 1)) and various techniques to identify the user can be used. For example, the received information can be a password, a parameter from a biometric measurement, a key, or a combination thereof.

Example passwords include, e.g., a numeric password that has been entered using a keypad on remote control, a keypad on a device, a touchtone phone, or a microphone connected to voice recognition software. The password can be an alphanumeric password entered using a keypad on a remote control or other device to specify letters, either by navigating an on-screen grid or using “cell phone” style text entry (e.g., push “2” twice for “b”), using an optional wired or wireless keyboard, a touchtone phone, or microphone connected to voice recognition software. The password can also be an arbitrary button combination, e.g., once in password entry mode, all remote control keys might be disabled except for “help” and “power” and could be used as part of the password.

Example biometric measurements include, e.g., a fingerprint measurement (e.g., a fingerprint transducer can be built into a remote control), a voiceprint measurement (e.g., a voiceprint recognizer can require a user to read an arbitrary sentence on a screen), and a retinal scan.

Example keys include, e.g., a magnetic stripe card, smart card, a physical key (traditional toothed key), a timing key (e.g., a timing recognition device that requires a user to push a specified sequence of buttons on the remote control in a specified rhythm).

Access control information can also be received at 21 0. Access control information is information that describes how access to content is to be controlled. The access control information can be received over a variety of input devices (such as user interface 120 (FIG. 1)).

An access control technique can be updated to reflect the received access control information at 215. Updating the access control technique can include storing the received access control information in association with the identity of a particular accessor or group of accessors to whom the access control information is relevant. For example, the access control information can be stored at information storage 122 (FIG. 1). Updating the access control technique can also include revising a list of acceptable content or other parameters in accordance with the received access control information.

FIG. 3 shows an example screenshot 300 displayed in a user interface of a system executing process 200 (FIG. 2). Screenshot 300 can be formed under the guidance of a data processing device (such as access control module 125 (FIG. 1)) on a display screen of a computer or television (such as user interface 120 or content rendering device 135 (FIG. 1)).

The system forming screenshot 300 has received a particular class of access control information, namely criteria that can be used to identify acceptable content. Screenshot 300 includes an accessor identifier 305, a criteria change section 310, a criteria change accept button 315, and a criteria change reject button 320. Accessor identifier 305 identifies a particular individual or group who accesses content. Criteria change section 310 is a portion of the user interface where various criteria are identified to an access controller. The association of accessor identifier 305 with criteria change section 310 on screenshot 300 can ensure that certain criteria for identifying acceptable content are used in systems and techniques that control access to content by the identified accessor. The criteria identified in criteria change section 310 are changeable by a controller to identify acceptable content. In particular, an active criteria indicator 325 identifies that genre criterion 330 is currently subject to change by a controller who, for example, can select one or more appropriate values from a list of potential genre values to change genre criterion 330.

Criteria change accept button 315 and criteria change reject button 320 allow a controller to accept or reject one or more changes made to criteria in criteria change section 310. When the controller accepts the changes using criterion change accept button 315, the system can update the access control technique to reflect the changes. The system can use the updated access control to control access to content by one or more content accessors by identifying acceptable content using the accepted criteria, as described further below.

FIG. 4 shows a table 400 of example classes of criteria that can be used to control access to content. In particular, table 400 includes a subject matter class 405, a timing class 410, an amount class 415, and a cost class 420. Classes 405, 410, 415, 420 are general categories of criteria that can be used to control access to content. Such criteria can belong to one or more of classes 405, 410, 415, 420. Also, criteria that do not fall within any of classes 405, 410, 415, 420 can be used to control access to content. The criteria in any of classes 405, 410, 415, 420 can be used to control access to content by identifying content that is acceptable, as discussed further below.

Subject matter class 405 includes criteria 425 that relate to the ratings of content (e.g., G, PG, PG-13, mature language, violence, . . . ), the channel on which the content is available (e.g., ESPN, THE DISCOVERY CHANNEL, . . . ), the genre of the content (e.g., educational, children's, action/adventure, western, . . . ), specific examples of content (e.g., the Superbowl, a particular program, or a particular episode of a program), whether the content is live or prerecorded, and the language of the content (e.g., Spanish, English, . . . ).

Timing class 410 includes criteria 430 that relate to the portion of the day (e.g., between 4 and 6 PM or specific half hour increments during the day, as illustrated in FIG. 6 below), the portion of the week (e.g., weekday vs. weekend), the day of the week (e.g., Sunday, Monday, . . . ), the season (e.g., summer vs. winter), and the school schedule (e.g., school day vs. vacation day). Amount class 415 includes criteria 435 that relate to daily limits, weekly limits, and a time bank for the duration of content. Cost class 420 includes a criterion 440 that relates to a limit on paid expenditures for access to content (e.g., pay-per-view expenditures, video on demand expenditures, or other interactive service (e.g., gaming) expenditures). Criterion 440 can apply to a specific category of content requiring expenditures or to all expenditures for access to content.

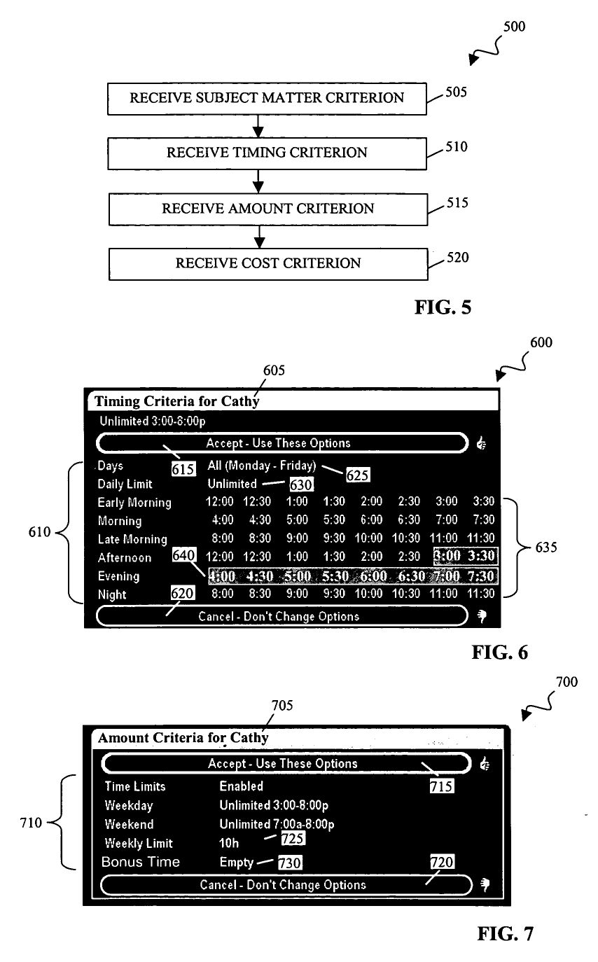

FIG. 5 shows a process 500 for receiving a particular class of access control information, namely criteria that can be used to identify acceptable content. Process 500 can be performed in isolation or as part of another process. For example, process 500 can be performed as part of step 210 in process 200 (FIG. 2).

Process 500 can begin upon receipt of a subject matter criterion at 505. A subject matter criterion relates to the subject matter of content that is acceptable for access. A received subject matter criterion can fall within subject matter class 405 (FIG. 4). FIG. 3, discussed above, shows a screenshot of a system receiving subject matter criteria.

A timing criterion can be received at 510. A timing criterion relates to the timing of content that is acceptable for access. A received timing criterion can fall within timing class 410 (FIG. 4). FIG. 6 shows a screenshot 600 displayed on a user interface of a system when receiving timing criteria from a user. Screenshot 600 can be formed under the guidance of a data processing device (such as access control module 125 (FIG. 1)) on a display screen of a computer or television (such as user interface 120 or content rendering device 135 (FIG. 1)).

Screenshot 600 includes an accessor identifier 605, a criteria change section 610, a criteria change accept button 615, and a criteria change reject button 620. Accessor identifier 605 identifies a particular individual who accesses content. Criteria change section 610 allows various criteria to be changeable by an access controller. Criteria change section 610 includes a day selection area 625, a daily limit input area 630, and a period selection area 635. Day selection area 625 allows a controller to select a one or more days for access to content. Daily limit input area 630 allows a controller to select a daily time limit on access to content. Daily limit input area 630 thus allows a controller to input an amount criterion, as described further below. Period selection area 635 allows a controller to select a certain period within one or more days for access to content. In particular, period selection area 635 includes an active period indicator 640 that identifies a particular time span (i.e., 3 PM-8 PM) when access to content is unlimited. Criteria change accept button 615 and criteria change reject button 620 allow a controller to accept or reject one or more changes made to criteria in criteria change section 610.

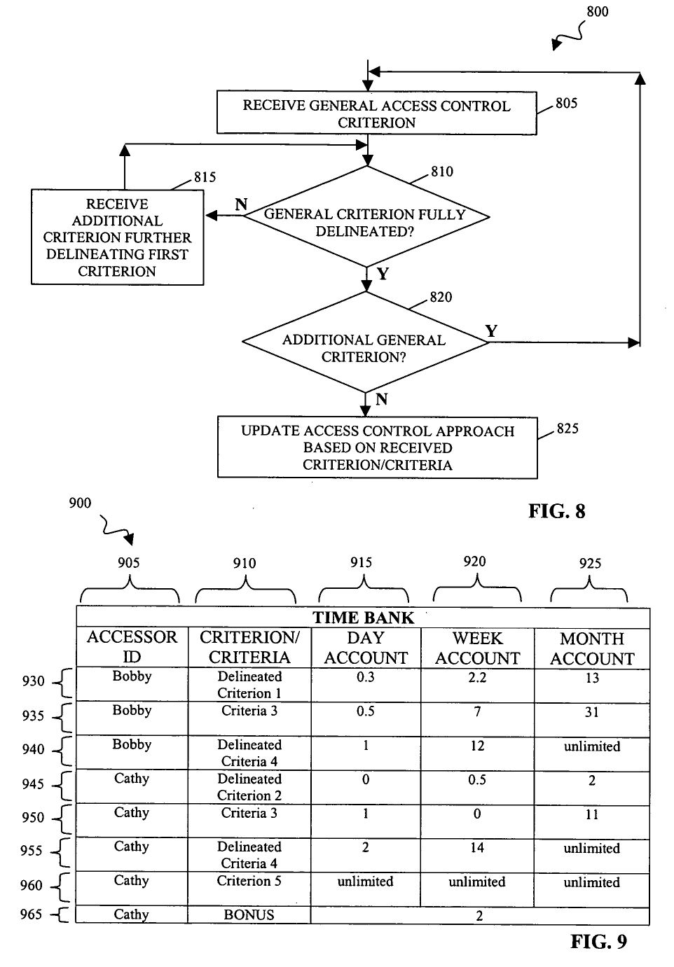

An amount criterion can be received at 515. An amount criterion relates to the amount of content that is acceptable for a given period. A received amount criterion can fall within amount class 415 (FIG. 4). As discussed above, an amount criterion can be received at daily limit input area 630 of screenshot 600 (FIG. 6). As another example, FIG. 7 shows a screenshot 700 displayed on a user interface of a system executing process 500 when receiving an amount criterion. Screenshot 700 can be formed under the guidance of a data processing device (such as access control module 125 (FIG. 1)) on a display screen of a computer or television (such as user interface 120 or content rendering device 135 (FIG. 1)). Screenshot 700 can be associated with screenshot 600 in that a portion of the information displayed in screenshot 700 reflects information received by a system displaying screenshot 600.

Screenshot 700 includes an accessor identifier 705, a criteria change section 710, a criteria change accept button 715, and a criteria change reject button 720. Accessor identifier 705 identifies a particular individual who accesses content. Criteria change section 710 allows various criteria to be changeable by an access controller. Criteria change section 710 includes a weekly limit input area 730 and a bonus time input area 730. Weekly limit input area 730 allows a controller to select a weekly time limit on access to content. Time can also be limited on a daily, weekly, or monthly basis. Bonus time input area 730 allows a controller to change a bonus time limit. A bonus time limit is an accounting of the time that a controller has allocated for access to content by an accessor that is independent of any timing criterion. Thus, bonus time can be expended by an accessor at any time, even when the accessor would normally be denied access to content due to the access failing to meet one or more timing criteria. Criteria change accept button 715 and criteria change reject button 720 allow a controller to accept or reject one or more changes made to criteria in criteria change section 710.

A cost criterion can be received at 520. A cost criterion relates to the cost of content that is to be enabled for access. A received cost criterion can fall within cost class 420 (FIG. 4).

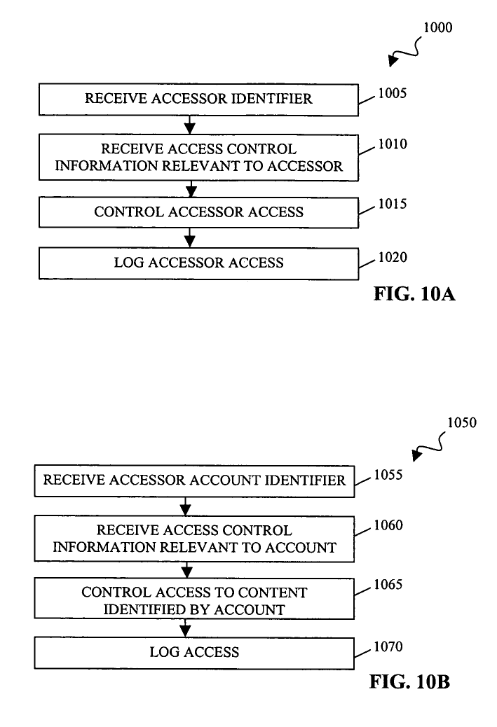

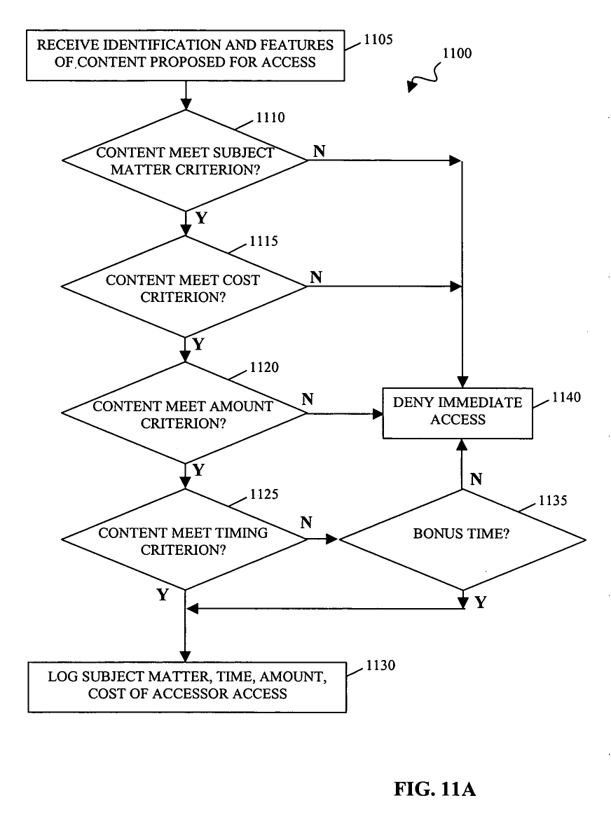

The received subject matter, timing, amount, and cost criteria can be used together to identify acceptable content. In particular, a system can require that a particular instance of content (e.g., a particular radio show, television program, or Internet website) meet every of the subject matter, timing, amount, and cost criteria. Examples of the use of such received criteria are given in FIGS. 10-15 below.

FIG. 8 shows another process 800 for receiving criteria that can be used to identify acceptable content. Process 800 can also be performed in isolation or as part of another process. For example, process 800 can be performed as part of step 210 in process 200 (FIG. 2), alone or in conjunction with process 500 (FIG. 5).

The system performing process 800 can receive a general access control criterion at 805. A control criterion is general when it identifies a broad category of content that can be further delineated by additional criteria. An example of a general access control criterion in subject matter class 405 (FIG. 4) is the genre of “educational content.” The “educational content” genre can be further delineated by additional criteria relating to the academic subject (e.g., history, science, math, . . . ) or relating to the target age of the audience (e.g., elementary school, high school, adult, . . . ). As another example, a general access control criterion in amount class 415 (FIG. 4) is the daily limit. The daily limit for a weekend day may be delineated by requiring that a certain percentage of the limit be dedicated to access during certain hours (e.g., before 9:30 AM) of the day, rather than spread out through the day.

The system performing process 800 can determine if the general access control criterion is fully delineated at decision 810. A fully delineated general access control criterion is an access control criterion for which no further delineation is desired. The system can determine if an access control criterion is fully delineated by receiving user input indicating that no delineation is desired. When the system determines that the general access control criterion is not fully delineated, the system can receive an additional criterion that further delineates the general access control criterion at 815. The additional criterion can be received from a user, for example, when the user selects a particular delineating criteria from a list of potential delineating criteria.

When the system determines that the general access control criterion is fully delineated, the system can determine if an additional general criterion is to be used in controlling access to content at decision 820. The system can determine if an additional general criterion is to be used by receiving user input identifying that an additional general criterion (such as a general criterion from another criteria class) is desired. When the system determines that an additional general criterion is to be used, the system can receive the additional general criterion at 805. When the system determines that an additional general criterion is not to be used, the system can update the access control technique using the received criterion/criteria at 825.

The received subject matter, timing, amount, and cost criteria can be used together to identify acceptable content. Examples of the use of such received criteria are given in FIGS. 10-15 below.

FIG. 9 shows a graphic associated with the display of entries in a time bank where general criteria from two different criteria classes can be used to control access to content. A time bank controls an accounting of the time amount of content that a controller has allocated for access to certain content by a certain accessor. Time bank 900 includes collections of accessor identifiers 905, criteria 910, day accounts 915, week accounts 920, and month accounts 925. Accessor identifiers 905 identify a particular accessor of content whose access to content is controlled. Criteria 910 identify criterion and criteria that can be used to identify acceptable content. For example, criteria 910 can be subject matter criteria that identify specific acceptable content as acceptable for viewing. Day accounts 915, week accounts 920, and month accounts 925 all identify rations of time amounts of content access that are acceptable for the associated period. For example, day accounts 915 identify the ration of time acceptable for access to content that day.

Entries in collections 905, 910, 915, 920, 925 are associated in a series of records 930, 935, 940, 945, 950, 955, 960, 965. Records 930, 935, 940, 945, 950, 955, 960 each identify a particular accessor, criteria identifying specific acceptable content, and the amount of time acceptable for access to that specific content that day, week, and month. During access to content by an accessor, rations in collections 915, 920, 925 can be updated to reflect the access, as discussed further below. Record 965 identifies a particular accessor, the absence of criteria identifying the timing of acceptable access to content (“BONUS” in collection 910), and the amount of time that a controller has allocated for such access to content independent of the timing of the access. In particular, the amount of bonus time in record 965 is independent of the day, week, and month of the access. Further, the amount of bonus time in record 965 can be rolled-over to subsequent days, weeks, and months.

FIG. 10A shows a process 1000 for controlling access to content. Process 1000 can be performed for live or prerecorded content. Process 1000 can be performed by a stand-alone system that communicates with an appliance or other apparatus for rendering content. For example, process 1000 can be performed by access controller 105 (FIG. 1). Process 1000 can also be performed by a system of elements built into an apparatus for rendering content.

Information that identifies a particular accessor is received at 1005. The information can be received over a variety of input devices (such as user identification input 115 (FIG. 1)) and various techniques to identify the accessor can be used. For example, the received information can be a password, a parameter from a biometric measurement, a key, or a combination thereof.

Access control information that is relevant to the identified accessor is received at 1010. For example, such access control information can be retrieved from a data storage device (such as information storage 122 (FIG. 1)) where it was stored after receipt from a controller (using e.g., a process such as process 200 (FIG. 2)). The received access control information can reflect updates made by a controller using a process such as process 200 (FIG. 2).

The access to content by the accessor can be controlled at 1015. Access control can include allowing access to certain channels or programs with certain ratings based on access control information that simply identifies acceptable content. This can be done whether the programming is “live” or “prerecorded.” Various techniques to control access to content can be used, as discussed further below. The content accessed by the accessor can be logged at 130. Logging the accessed content can include recording the name and amount of content accessed in an access log and changing entries in a time bank.

FIG. 10B shows a process 1050 for controlling access to content. Process 1050 can be performed for live or prerecorded content. Process 1050 can be performed by a stand-alone system that communicates with an appliance or other apparatus for rendering content. For example, process 1050 can be performed by access controller 105 (FIG. 1). Process 1050 can also be performed by a system of elements built into an apparatus for rendering content.

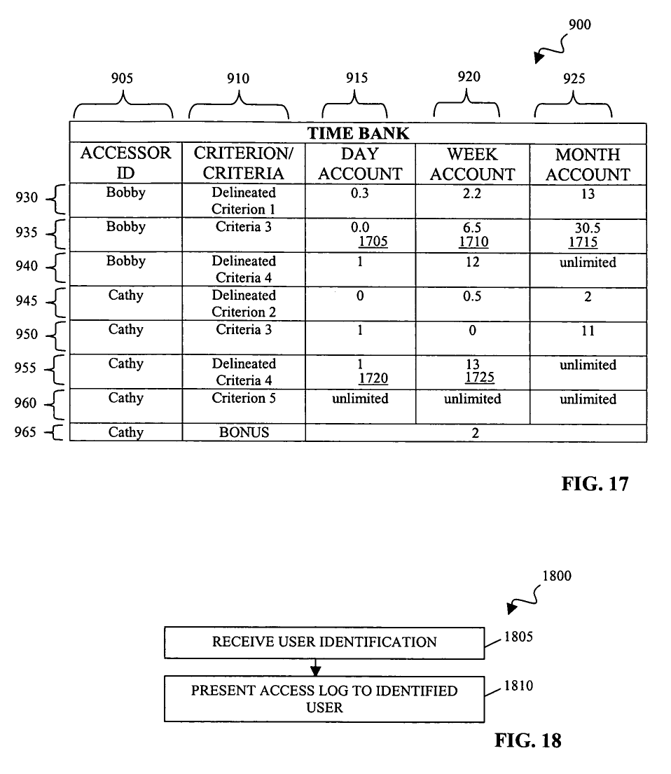

Information that identifies a particular accessor account is received at 1055. An accessor account is a record of access control information that relates to a particular category of acceptable content. Categories of acceptable content can be defined by one or more criteria for identifying acceptable content. For example, each of records 930, 935, 940, 945, 950, 955, 960 in time bank 900 (FIGS. 9 and 17) be associated with different accessor accounts. Accessor accounts can be associated with one or more individual accessors and hence identify the accessors. An accessor account can include criteria for identifying acceptable content, time bank information, and an access log. Accessor accounts can be identified by information received over any of a variety of input devices (such as user identification input 115 (FIG. 1)).

Access control information that is relevant to the identified account is received at 1060. For example, such access control information can be retrieved from a data storage device (such as information storage device 122 (FIG. 1)) where it was stored after receipt from a controller.

The access to content falling within the particular category of account content can be controlled at 1065 and the content accessed by the accessor can be logged at 1070. Logging the accessed content can include recording the name and amount of content accessed in an access log in the account, as well as changing entries in a time bank in the account.

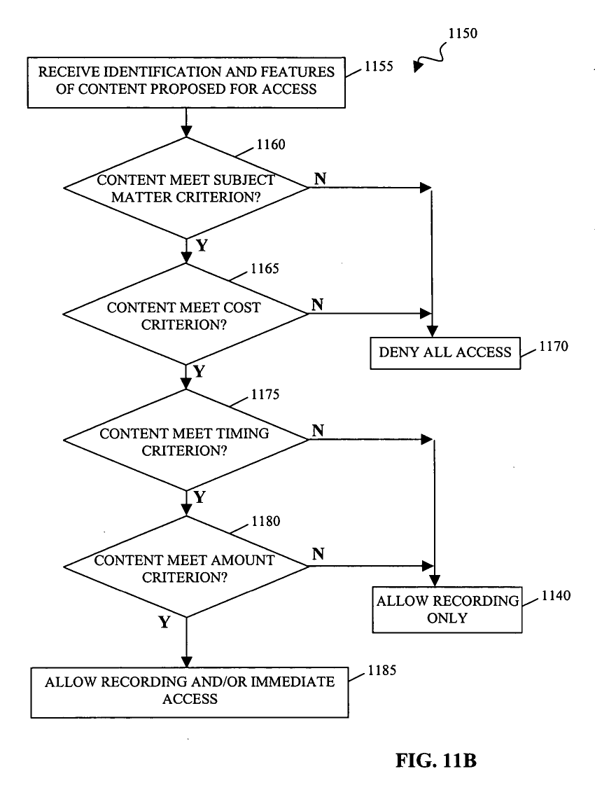

FIG. 11A shows a process 1100 for controlling access to content. Process 1100 can be performed for live or prerecorded content. Process 1100 can be performed in isolation or as part of another process. For example, process 1100 can be performed as part of step 1015 in process 1000 (FIG. 10A) or step 1065 in process 1050 (FIG. 10B).

An identification of content and a description of features of the content that an accessor proposes to access is received at 1105. For example, identification and feature information can be received as metadata transmitted along with content. Alternatively, the identification and feature information can be determined by comparing current time and date information with a transmission schedule for a particular source of content (e.g., a particular television or radio channel or a particular website).

Using the received content identification and feature information, a determination is made as to whether or not the identified content meets one or more subject matter criteria at decision 1110. For example, the identified content can meet subject matter criteria by having a subject features that are identified as acceptable by the subject matter criteria. When the identified content is determined to fail to regard an acceptable subject matter, access to the content is denied at 1140.

When the identified content is determined to regard acceptable subject matter, a determination is made as to whether or not the identified content meets one or more cost criteria at decision 1115. For example, the identified content can meet cost criteria when a cost allowance for access to the identified content is not exceeded. When the identified content is determined to fail to meet the one or more cost criteria, access to the content is denied at 1140.

When the identified content is determined to meet the one or more cost criteria, a determination is made as to whether or not the identified content meets one or more amount criteria at decision 1120. For example, the identified content can meet amount criteria when an entry in an account at a time bank indicates that additional access time is allocated for the identified content. When the identified content is determined to fail to meet the one or more amount criteria, access to the content is denied at 1140.

When the identified content is determined to meet the one or more amount criteria, a determination is made as to whether or not the identified content meets one or more timing criteria at decision 1125. For example, the identified content can meet timing criteria by occurring at a time that is identified as acceptable by the timing criteria. When the identified content is determined to meet the one or more cost criteria, access is allowed and a log of the subject matter, time, amount, and cost of the access is recorded at 1130. For example, the system can add a record to an access log such as access log 1000 (FIG. 10).

When the identified content is determined to fail to meet the one or more timing criteria, a determination as to whether or not bonus time is to be expended to allow access to the content is made at decision 1135. The determination can be made by determining if the accessor has any allocated bonus time (such as shown in record 965 of time bank 900 (FIG. 9) and querying the accessor if the accessor wishes to expend the allocated bonus time. When it is determined that bonus time is not to be expended (e.g., a negative response to the query is received), immediate access to the content is denied at 1140. When it is determined that bonus time is to be expended, access to the content is immediately allowed and a log of the subject matter, time, amount, and cost of the access is recorded at 1130.

The processing steps set forth in FIG. 11A can be rearranged and/or one or more of the processing steps can be omitted in accordance with the access control information specified by an access controller.

FIG. 11B shows a process 1150 for controlling access to content. Process 1150 is adapted to controlling access to live content in a system including a content recording device such as a digital video recorder (DVR). Process 1150 can be performed in isolation or as part of another process. For example, process 1150 can be performed as part of step 1015 in process 1000 (FIG. 10A) or step 1065 in process 1050 (FIG. 10B).

An identification of content and a description of features of the content that an accessor proposes to access is received at 1155. Using the received content identification and feature information, a determination is made as to whether or not the identified content meets one or more subject matter criteria at decision 1160 and as to whether or not the identified content meets one or more cost criteria at decision 1165. When the identified content is determined to fail to regard an acceptable subject matter or to fail to meet the one or more cost criteria, all access to the content is denied at 1170.

When the identified content is determined to regard acceptable subject matter and to meet the one or more cost criteria, a determination is made as to whether or not the identified content meets one or more timing criteria at decision 1175 and as to whether or not the identified content meets one or more amount criteria at decision 1180. When the identified content is determined to fail to meet one or more timing criteria or to fail to meet one or more amount criteria, only recording of the identified content is allowed.

When the identified content is determined to meet the one or more timing criteria and to meet the one or more amount criteria, immediate access and/or recording is allowed at 1185. A log of the subject matter, time, amount, and cost of the access can be recorded as appropriate.

The processing steps set forth in FIG. 11B can be rearranged and/or one or more of the processing steps can be omitted in accordance with the access control information specified by an access controller.

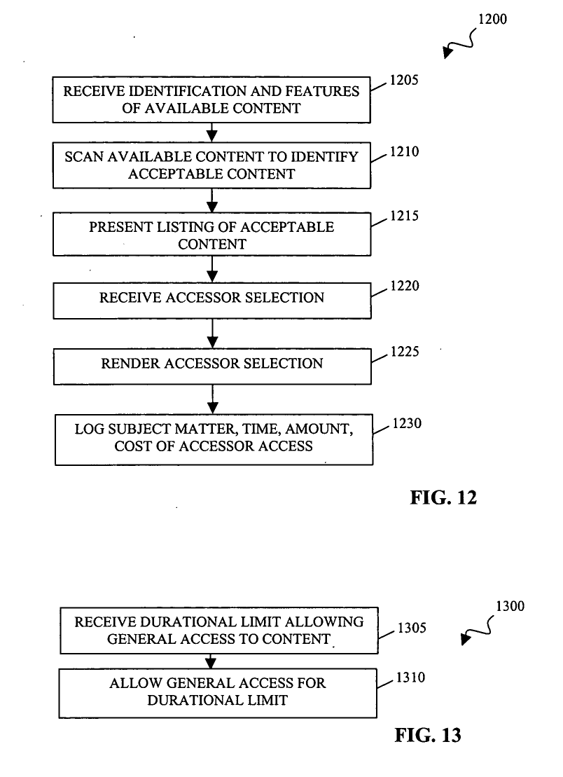

FIG. 12 shows another process 1200 for controlling access to content. Process 1200 can be performed for live or prerecorded content. Process 1200 can also be performed in isolation or as part of another process. For example, process 1200 can be performed as part of step 1015 in process 1000 (FIG. 10A) or step 1065 in process 1050 (FIG. 10B), alone or in conjunction with process 1100 (FIG. 11A) and/or process 1150 (FIG. 11B).

An identification of the currently available content and a description of the features of the currently available content are received at 1205. Currently available content is content that can be immediately rendered for any user. Currently available content includes prerecorded content that is available by way of a playback device as well as content that is currently receivable by a content rendering apparatus. An identification and feature description of all the currently available content or of a subset of all of the currently available content can be received.

The received identifications and descriptions are scanned to identify acceptable content that is currently available at 1210. For example, a determination can be made as to whether or not the currently available content meets any subject matter, time, amount, and cost criteria for a particular accessor. A list of the currently available acceptable content is presented to the accessor at 1215. The list can be exhaustive in that it identifies the all of the content currently available. The list can also include information that identifies why the content is considered acceptable. The information can include a description of the subject matter of the acceptable content and account entries in the accessor's time bank for content of that subject matter.

An accessor's selection from the list is received at 1220 and the content rendered at 1225. The system can log the accessor's access at 1230. The processing steps set forth in FIG. 12 can be rearranged and/or one or more of the processing steps can be omitted in accordance with access control information specified by an access controller.

FIG. 13 shows another process 1300 for controlling access to content. Process 1300 can be performed for live or prerecorded content. Process 1300 can also be performed in isolation or as part of another process. For example, process 1300 can be performed as part of step 1015 in process 1000 (FIG. 10A) or step 1065 in process 1050 (FIG. 10B), alone or in conjunction with process 1100 (FIG. 11A), process 1150 (FIG. 11B), and/or process 1200 (FIG. 12).

A durational limit allowing general access to content can be received at 1305. A durational limit is a period if time in which general access to content is to be allowed. Access to content is general when all content is acceptable by default. Default acceptability indicates that all content is acceptable except for content that is explicitly identified as unacceptable. Unacceptable content can be explicitly identified by name (e.g., a specific television program) or by characteristics (e.g., having a certain rating).

General access to content can be allowed for the period specified in the durational limit at 1310. Thus, the system can allow relatively broad access to content using a durational limit that allows access for a specified period of time (e.g., for two hours while parents leave children with a babysitter).

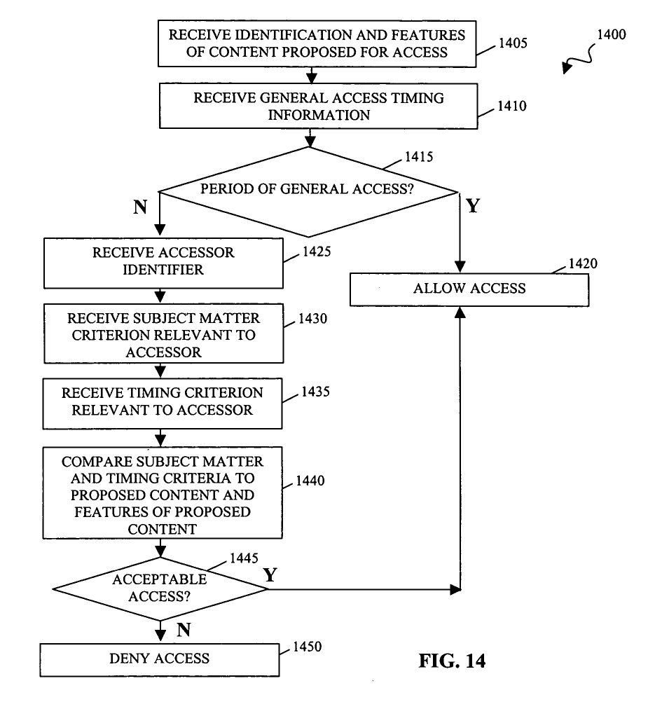

FIG. 14 shows another process 1400 for controlling access to content. Process 1400 can be performed for live or prerecorded content. Process 1400 can also be performed in isolation or as part of another process. For example, process 1400 can be performed as part of step 1015 in process 1000 (FIG. 10A) or step 1065 in process 1050 (FIG. 10B), alone or in conjunction with process 1100 (FIG. 11A), process 1150 (FIG. 11B), process 1200 (FIG. 12), and/or process 1300 (FIG. 13).

An identification and a description of the features of content that is proposed for access are received at 1405 and general access timing information is received at 1410. General access timing information is a category of timing criterion. In particular, general access timing information identifies the timing of a period of general access when all content is acceptable by default.

A determination is made as to whether or not the current time falls within a period of general access at decision 1415. When the current time is determined to fall within a period of general access, access to all content that is not explicitly identified as unacceptable is allowed at 1420. There is no need to identify an accessor or log a record of the accessor's access to content.

When the current time is determined to fall outside a period of general access, an accessor identifier is received at 1425. A subject matter criterion relevant to the identified accessor is received at 1430 and a timing criterion relevant to the identified accessor is received at 1435. The criteria can be received by retrieval from a data storage device such as information storage device 122 (FIG. 1). Cost and amount criteria relevant to the identified accessor can also be received.

The subject matter and timing criteria are compared to the proposed content and the features of proposed content at 1440. For example, the name of a television program can be compared to a list of specifically allowed television programs. As another example, the rating of the content can be compared to a list of allowed ratings. A determination is made as to whether or not the content is acceptable for access by the identified accessor at 1445. When the content is determined to be acceptable, access to all content that is not explicitly identified as unacceptable is allowed at 1420. When the content is determined to be unacceptable, access to the proposed content is denied at 1450.

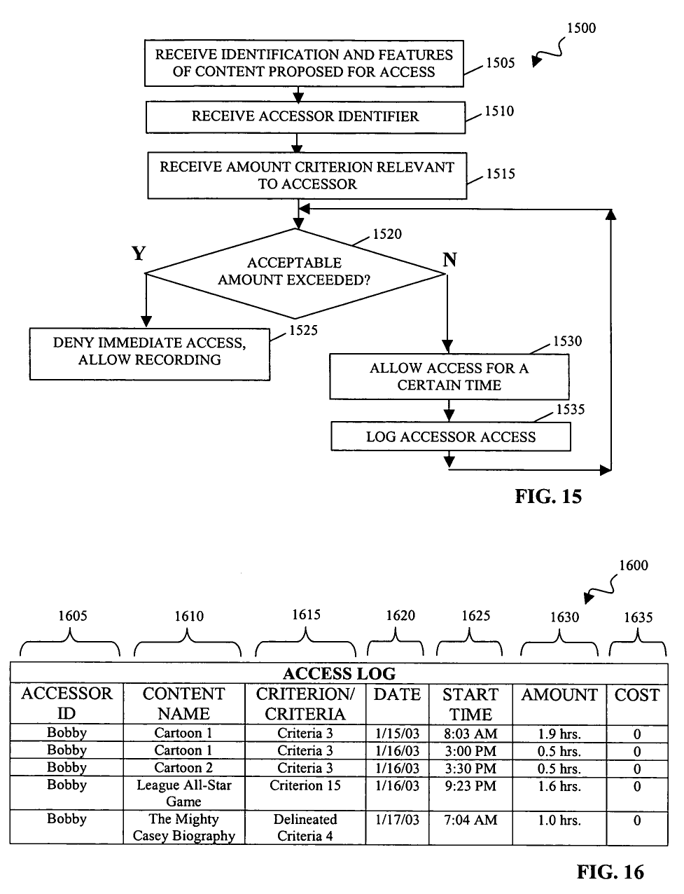

FIG. 15 shows another process 1500 for controlling access to content. Process 1500 can be performed for live or prerecorded content. Process 1500 can also be performed in isolation or as part of another process. For example, process 1500 can be performed as part of step 1015 in process 1000 (FIG. 10A) or step 1065 in process 1050 (FIG. 10B), alone or in conjunction with process 1100 (FIG. 11A), process 1150 (FIG. 11B), process 1200 (FIG. 12), process 1300 (FIG. 13), and/or process 1400 (FIG. 14).

An identification and a description of the features of content that is proposed for access are received at 1505 and an accessor identifier is received at 1510. An amount criterion relevant to the identified accessor is received at 1515. The amount criterion can include a ration of a particular class or category of content. The ration can be identified, e.g., on a per-day, per-week, or a per-month basis. The ration can be particular to a subject matter of content and/or a timing of content. For example, a first ration may exist for Saturday morning cartoons, a second ration may exist for Saturday morning educational programming, and a third ration may exist for weekday afternoon cartoons. As another example, a first ration may exist for a first group of television channels (e.g., CARTOON NETWORK, DISNEY) while other television channels may have unlimited or different rations (e.g., PBS, DISCOVERY CHANNEL). In one implementation, unused rations can be carried over to a subsequent period up to an accumulated maximum in an account such as a time bank.

A determination is made as to whether or not an acceptable amount of the proposed content has been exceeded at 1520. For example, the amount of content of the same class or category as the proposed content that has been accessed in the past can be compared with a ration amount for that class or category. When it is determined that the acceptable amount has been exceeded, immediate access to the proposed content is denied but recording is allowed at 1525.

When it is determined that the acceptable amount has not been exceeded, immediate access to the proposed content is allowed for a certain time at 1530 and the accessor's access is logged at 1535. The access logging can include an update to an entry in a time bank or other mechanism for keeping track of the amount of content accessed. After the certain time has lapsed, another determination is made as to whether or not an acceptable amount of the proposed content has been exceeded in light of the current access.

In any of these processes for controlling access to content, after accessor identification information has been received, a barrier specifically tailored to the identified accessor can be presented. Such a tailored barrier can include a query tailored to other items for which the accessor is responsible. For example, the query can inquire as to whether the accessor has finished his or her homework, walked the dog, done the dishes, or practiced the trombone.

FIG. 16 shows an example access log 1600. Access log 1600 is a historical record of the particular content accessed by one or more accessors. Access log 1600 includes collections of accessor identity information 1605, content name information 1610, criteria information 1615, access date information 1620, access time information 1625, access duration information 1630, and access cost information 1635. Accessor identity information 1605 identifies the particular accessors who accessed content. Content name information 1610 identifies the accessed content by name. Content name information 1610 can include other descriptive information such the channel of the accessed content, a description of the accessed content, and a rating of the accessed content. Criteria information 1615 identifies one or more criteria met by the accessed content. Access date information 1620 identifies the dates when content was accessed. Access time information 1625 identifies the times when content was accessed on the date identified in access date information 1620. Access duration information 1630 identifies the durations for which content was accessed. Access cost information 1635 identifies the cost of the accessed content. When an accessor accesses content, a new record can be added to access log 1600, recording the accessor's identity, the content name, criteria met by the content, the access date, time and cost, as well as the duration of the access in access log 1600. The system can also log access to determine pay-per-view, video on demand, and interactive service usage and billing. The system can also be used to establish a system for billing on a usage-per-time-period basis.

Logging the accessed content can also include updating account entries in a time bank. FIG. 17 shows time bank 900 with updated entries 1705, 1710, 1715, 1720, 1725. Entries 1705, 1710, 1715 have been updated to log an access to 0.5 hours worth of content that met criteria set “3” by accessor “Bobby,” whereas entries 1720, 1725 have been updated to log an access to 1.0 hours worth of content that met delineated criteria set “4” by accessor “Cathy.”

FIG. 18 shows a process 1800 for controlling access to content. Process 1800 can be performed by a stand-alone system that communicates with an appliance or other apparatus for rendering content. For example, process 1800 can be performed by access controller 105 (FIG. 1). Process 1800 can also be performed by a system of elements built into an apparatus for rendering content.

User identification information can be received at 1805. The user identification information can identify a controller or an accessor of content. Various techniques to identify the user can be used. For example, the received information can be a password, a parameter from a biometric measurement, a key, or a combination thereof.

An access log can be presented to the identified user at 1810. For example, an access log such as access log 1600 (FIG. 16) or a time bank statement that reflects the entries in time bank 900 (FIGS. 9 and 17) can be displayed for the user.

When the access log is presented to a controller, the controller can monitor access to content by the accessor. For example, parents can monitor their children's viewing habits and discuss the choices with the children. The system can log all usage of the device or usage by a subset of users or at certain times. The log can include an identification of the accessed content and the time of access, as well as other factors such as the percent of the content accessed and a description and rating of the content accessed.

When the access log is presented to an accessor, the accessor can monitor the accessor's own access to content. This allows the accessor to review access history and to budget future access based on the acceptability of the content according to the parameters defined by the controller.

A number of embodiments of the invention have been described. Nevertheless, it will be understood that various modifications may be made without departing from the spirit and scope of the invention. For example, a system performing process 500 need not receive all of a subject matter criterion, a timing criterion, an amount criterion, and a cost criterion. Rather, the system can receive a controller selection that specifies which of the criteria is to be received. The system can then receive the specified criterion without receiving the other criteria. As another example, access controller 105 and content access device 110 are shown as stand-alone units in system 100 (FIG. 1). However, access controller 105 can be built into content access device 110 and share common housing and input/output elements. The data connections between access controller 105 and content access device 110 (and within access controller 105 and content access device 110) can be wired or wireless. For example, access controller 105 can be remote from content access device 110 in that access controller 105 (or a constituent element such as information storage device 122) is located in a different room from content access device 110.

As another example implementation, a time bank and an access log can be combined into a single collection of data. Accordingly, other implementations are within the scope of the following claims.

What is claimed is:

1. A method for controlling access to television content, comprising:
receiving a criterion identifying acceptable television content for a certain accessor;
receiving information describing features of currently available television content;
comparing the features with the criterion; and
allowing the accessor to view the television content only if the features of the television content meet the identifying criterion.

2. The method of claim 1, wherein receiving the criterion comprises receiving a subject matter criterion identifying a subject matter of content that is acceptable.

3. The method of claim 1, wherein receiving the criterion comprises receiving the name of a particular show that is acceptable for the certain accessor.

4. The method of claim 1, wherein receiving the information describing features of currently available television content comprises receiving metadata associated with the currently available television content.

5. The method of claim 1, wherein receiving the criterion comprises receiving criteria relating to two or more of a rating of the acceptable television content, a channel of the acceptable television content, and a genre of the acceptable television content.

6. The method of claim 1, wherein receiving the criterion comprises receiving an indication that television viewing at a current time of day is acceptable.

7. The method of claim 1, wherein receiving information comprises receiving information describing features of prerecorded television content.

8. The method of claim 1, wherein receiving the criterion comprises receiving a criterion identifying acceptable television content for a certain individual accessor.

9. A method for controlling access to content, comprising:
receiving a description of subject matter of content that is acceptable for access by a content accessor;
receiving a description of a time when access to content by the accessor is acceptable; and
allowing the accessor to access content having the acceptable subject matter only at the described acceptable time.

10. The method of claim 9, further comprising allowing the accessor to record content having the acceptable subject matter outside the described acceptable time.

11. The method of claim 9, wherein receiving the description of the subject matter comprises:
receiving a general subject matter criterion that identifies a general subject matter that is acceptable; and
receiving an additional subject matter criterion that delineates the general subject matter criterion to identify a portion of the general subject matter as acceptable.

12. The method of claim 9, further comprising establishing an account relating to a category of content described by the received description.

13. The method of claim 9, further comprising receiving a description of an amount of access to content by the accessor that is acceptable.

14. The method of claim 13, wherein receiving the description of the amount comprises receiving a daily amount criterion identifying a daily amount of access to content that is acceptable.

15. The method of claim 13, wherein receiving the description of the amount comprises receiving an amount criterion identifying the amount of access to content having the described subject matter.

16. The method of claim 13, wherein allowing the accessor to access the content comprises allowing the accessor to access the content having the acceptable subject matter only at the described acceptable time up to the acceptable amount.

17. The method of claim 16, further comprising allowing the accessor to record content having the acceptable subject matter but beyond the acceptable amount.

18. The method of claim 9, further comprising receiving a cost criterion identifying a monetary cost of access to content by the accessor that is acceptable.

19. The method of claim 9, wherein receiving the description of the timing comprises receiving a timing criterion identifying a time when access to content having the described subject matter is acceptable.

20. The method of claim 9, further comprising:
determining whether or not a bonus time allocated for access to content is to be expended, the bonus time being independent of the time when access to content by the accessor is acceptable; and
allowing the accessor to access content regardless of the acceptability of the time when access to content by the accessor is acceptable based on a determination that the bonus time is to be expended.

21. A method for controlling access to television content, comprising:
identifying a viewer of television content;
logging the viewer's access to the television content in a log; and
presenting the log of the viewer's access to a requester of the log.

22. The method of claim 21, wherein presenting the log comprises presenting a list identifying a name of the television content and a time of the access to the television content.

23. The method of claim 21, wherein presenting the log comprises presenting a criterion met by the content, the criterion identifying acceptable television content.

24. The method of claim 21, further comprising controlling the viewer's access to the television content.

25. The method of claim 22, wherein controlling the viewer's access comprises allowing the accessor to view the television content only if features of the television content meet a criterion identifying acceptable television content.

26. The method of claim 25, wherein allowing the accessor to view the television content comprises allowing the accessor to view the television content only if features of the television content meet a subject matter criterion identifying a subject matter of content that is acceptable.

27. The method of claim 21, wherein presenting the log of the viewer's access comprising presenting the log to a controller who can define an access control technique used to control the viewer's access to the television content.

28. A system comprising:
an access controller to control access of a user to television content, the access controller including
an identification signal receiver configured to receive a signal identifying an individual,
an information storage device to store access control information to identify television content that is acceptable for a certain accessor, and
access control logic to implement an access control technique allowing the certain accessor access to the television content identified as acceptable by the information stored in the information storage device.

29. The system of claim 28, wherein the access control logic comprises machine-readable instructions implemented in a data processing device.

30. The system of claim 28, further comprising a television display device to render the television content, the television display device being integrated into a single housing with the access controller.

31. The system of claim 28, wherein the identification signal receiver comprises an infrared receiver to receive information that identifies the individual.

32. The system of claim 28, wherein the access controller further comprises a display screen to interact with a user who controls the access of the certain accessor to television content.

33. The system of claim 28, wherein the information storage device comprises a disk drive to store machine-readable information.
